(19) United States
(12) Patent Application Publication
(10) Pub. No.: US 2018/0119289 A1
(43) Pub. Date: May 3, 2018

(54) CORROSION INHIBITOR FORMULATIONS

(71) Applicant: RHODIA OPERATIONS, Paris (FR)

(72) Inventor: Kevan HATCHMAN, West Midlands (GB)

(21) Appl. No.: 15/572,406

(22) PCT Filed: May 12, 2016
(86) PCT No.: PCT/EP2016/060645

§ 371 Date: Nov. 7, 2017

Related U.S. Application Data
(60) Provisional application No. 62/160,837, filed on May 13, 2015.

(51) Int. Cl. C23F 11/12; C23F 11/14; C09K 8/54; C10G 75/02

(52) U.S. Cl. CPC C23F 11/12; C23F 11/145; C09K 2208/32; C09K 8/54; C10G 75/02; C23F 11/143

(57) ABSTRACT

The instant invention relates to a corrosion inhibitor composition that contains: (a) at least one biodegradable polyhydroxyacid and/or polyhydroxylated derivative thereof, preferably a polyhydroxyacid that may be in all or part in the form a polyhydroxylated salt and/or a polyhydroxyamide; and (b) a biodegradable cationic compound having a molecular weight of less than 500 Da, preferably between 50 and 400 Da

The instant invention relates to corrosion inhibition mixtures especially suitable for decreasing or preventing corrosion of metal surfaces, such as steel metal surfaces, in presence of water and oxygen, said corrosion inhibition mixtures being typically intended for decreasing or preventing corrosion of metallic pipes and containers in contact with fluids such as oxygenated drilling fluids used in the scope of oil and gas extraction.

The management of corrosion problems is strategically important especially to oil production companies. Failure to implement an effective corrosion inhibition programme can lead to catastrophic results that are costly to rectify. In order to prevent/decrease corrosion, different kinds of inhibitors have been proposed. Most often, corrosion inhibition formulations disclosed so far include ingredients such as surfactants which adsorb on to the metal surface to form a protective barrier film.

A major disadvantage of commercially available oilfield corrosion inhibitor formulations is their environmental profile. As an example, one of the most widely used surfactant corrosion inhibitor chemistries in oilfield are those based on C₈-C₁₈ alkyl amines, C₈-C₁₈ alkyl diamines, C₈-C₁₈ alkyl amidoamines, C₈-C₁₈ alkyl hydroxyethyl or aminoethyl imidazolines, e.g. tall oil fatty acid derivatives, and quaternary C₈-C₁₈ alkyl ammonium salts. Although their performance attributes are well known, these compounds are often incompatible with other components such as anionic corrosion inhibitors, e.g. phosphate esters, or they are insoluble or weakly soluble in the production fluids, thereby leading to a problematic separation phase processus known as “gunking”. Moreover, they generally have a poor biodegradability and a potential to bioaccumulate in the ecosystem, and they are harmful or toxic to aquatic species.

Alternatives solutions have been proposed in order to meet the requirements of global environmental legislation, including e.g. the use of alkyl amphoacetates as described in WO2012/063055 or alkyl polyglucoside/polyaspartate of WO2007/063069. These compounds, however, have limitations in their performance attributes such as chemical and/or thermal stability and compatibility with brines, especially with high TDS (total dissolved solids) brines.

More generally, the use of corrosion inhibitors surfactants tends to lead to emulsification of hydrocarbons and the generation of foam in production equipment, that are to be avoided. Additional costs are often incurred by treating these problems, typically with an addition of demulsifiers, water clarifiers and/or foam control agents.

The instant invention aims at providing corrosion inhibitors that allow to avoid the above drawbacks. More precisely, one aim of the invention is to provide a corrosion inhibitor formulation that meets the requirements of global environmental legislation and that are able to prevent/inhibit corrosion in presence of oxygen, even in brines, especially TDS brines, used in the oilfield.

To this end, the instant invention provides a corrosion inhibitor composition that contains an association of biodegradable components that have now be found as acting together to provide an efficient anticorrosion effect especially in oxygenated high TDS brines used in oilfield.

More precisely, according to a first aspect, one subject matter of the instant invention is a corrosion inhibitor composition that contains, among other possible ingredient:
(a) at least one biodegradable polyhydroxyacid and/or polyhydroxylated derivative thereof, preferably a polyhydroxyacid that may be in all or part in the form a polyhydroxylated salt and/or a polyhydroxyamide; and
(b) at least a biodegradable cationic compound having a molecular weight of less than 500 Da, preferably between 50 and 400 Da, for example between 100 and 200 Da.

Another subject matter of the instant invention is the use of a composition as defined above for providing an anticorrosion effect on a metallic surface, for example on a metallic surface in contact with an oilfield fluid, especially an oxygenated oilfield fluid, e.g. an oxygenated oilfield brine, typically a high TDS brine.

The polyhydroxyacid and/or polyhydroxylated derivative thereof as used in the composition of the invention (hereinafter referred as “compound (a)”) may especially be selected among:
biodegradable polyhydroxy acids, such as gluconic acid, tartaric acid, polyaspartic acid and/or glutamic acid,
gluconic acid being especially preferred;
ammonium or metal salts of such biodegradable polyhydroxy acids (especially alkali metal salts);
alkanolamine salts of such biodegradable polyhydroxy acids
polyhydroxy amides obtainable by reaction of alkanolamines with such biodegradable polyhydroxy acids;
mixtures thereof.

Compound (a) may especially be gluconic acid, preferably in all or part in the form of a salt (gluconate) or an amide as defined above.

Typically, a suitable biodegradable cationic compound to be used in the composition of the invention (hereinafter referred as “compound (b)”) may be:
a choline salt (choline being trimethyl (2-hydroxyethyl) ammonium hydroxide), such as choline chloride, for example, that has a molecular weight of about 140 Da, that is well biodegradable;
a (C₁-C₃ alkyl)trimethylammonium or di(C₁-C₃ alkyl) dimethylammonium salt (for example a halide, e.g. chloride, methosulfate or morpholine salt);
a dihydroxy tri(C₁-C₃ alkyl) ammonium halide or dihydroxy tri(C₁-C₃ hydroxyalkyl) ammonium halide, e.g. 2,3 dihydroxypropyl trimethyl ammonium chloride (for example PD Quat supplied by Dow Chemicals) which has a molecular weight of 170 Da;
a cationic compound as obtained by the hydrolysis of chlorohydroxalkyl tri(C₁-C₃ alkyl or hydroxalkyl) ammonium salts; or
a mixture of two or more of said salts.

Typically, compound (b) may be a choline salt, notably a choline halide such as choline chloride. An especially interesting composition according to the instant invention includes gluconic acid, preferably in all or part in the form of gluconate salts as compound (a) and a choline salt, preferably choline chloride as compound (b).

In the scope of the instant invention, it has now been surprisingly found that the addition of a low molecular cationic compound as defined above to the polyhydroxyacid and/or polyhydroxylated derivative thereof (a) enhanced the intrinsic anticorrosion qualities of said compound (a), leading to an especially high anticorrosion effect, sufficiently strong for inhibiting corrosion in presence of oxygen even in highly TDS brines used in oilfield.

Polyhydroxy acids, commonly used as biodegradable chelants and builders in cleaning formulations (water softeners), have also been identified in some publications as able to exhibit some corrosion inhibition. However, the corrosion inhibition described so far with such compounds was well lower than the unexpected anticorrosion effect that the inventors have now discovered when they are use in association with compound (b).

The inventors have observed that, in the presence of electrolyte such as brine, the mixture of compounds (a) and (b) of the invention reduce the corrosion rate of the metal, in a better way than the individual components, even in the presence of water hardness ions such as calcium. Which is especially surprising since the compound (b) as such, used so far essentially as shale swelling inhibitor in drilling fluids (see e.g. EP 634 468 A1), does not reduce alone the corrosion rate.

The association of compounds (a) and (b) provides another non negligible advantage, that is that they do not induce the formation or foam, and does not form emulsion when in contact with hydrocarbon such as those present in the extracted crude oil, contrary to the surfactant suggested in the prior art. The invention consequently allows to provide a not foaming and not emulsifying composition if needed, with the only condition not to introduce any additive that would induces a foaming or emulsification. In this connection, the compounds(a) and (b) are for example preferably not used together with an anticorrosion surfactant. Compositions comprising compounds (a) and (b) without any other additives inducing a forming or emulsionning effect constitute another specific aspect of the instant invention.

Preferably, but not necessarily, the composition of the invention further includes:
(c) an antioxidant, preferably biodegradable, for example selected from ascorbic acid and/or a salt thereof such as sodium ascorbate, isoascorbic acid (also called erythorbic acid) and/or a salt thereof such as sodium iso-ascorbate (sodium erythorbate); lactobionic acid and/or a salt thereof; and mixtures thereof.

Such an antioxidant (also referred in the instant description as “compound (c)”) may be used alone or in admixture with an oxygen scavenger, for example ammonium or alkali metal bisulfites and alkylhydroxylamines, e.g. diethylhydroxylamine (DEHA).

According to a specifically interesting embodiment, a composition according to the invention includes gluconic acid, preferably in all or part in the form of gluconate salts as compound (a); a choline salt, preferably choline chloride as compound (b); and (c) an antioxydant, typically isoascorbic acid and/or a salt thereof, with or without additional oxygen scavenger. The above antioxidant do not jeopardize the non-foaming and non-emulsifying properties.

Whatever a antioxidant is used or not, the inventors have discovered that it is advantageous to introduce a pH buffer in the composition. In this scope, the use of a buffer comprising or consisting in calcium oxide CaO is especially interesting, especially when compound (a) is a gluconate used with a choline salt as compound (b). The buffer, especially when it contains CaO, allows to obtain even better anticorrosion properties. Especially, it maintains the anticorrosion properties of the composition over long period, typically at least during 24 hours.

Thus, according to a interesting embodiment, the composition of the invention furthermore contains:
(d) a pH buffer, preferably containing CaO.

Besides, the work performed by the inventors has shown that the association of compound (a) and antioxidant (c), for example gluconate and isoascorbate, induce a more effective anticorrosion effect than with each of the compound alone, even without making use of compound (b), and that the obtained anticorrosion effect is especially high in the presence of a buffer, and notably when the buffer is based on calcium oxide. In this scope, a specific object of the instant invention is a composition comprising the association of compound (a), an antioxidant (c) and a buffer (d) preferably including calcium oxide.

Different features and specific embodiments of the invention are described in more details herein-after.

### The Compound (a)

Polyhydroxy acids especially useful as compound (a) according to the instant invention include gluconic acid, tartaric acid, glucoheptonic acid and polyaspartic acid, preferably in the form of biodegradable salts thereof, that can be e.g. carboxylates, alkanolamine, alkali metal (Na, K, Ca), Fe, Zn or Mb salts of gluconates, tartarates, glucoheptonates (α or β form), glutamic acid N,N-diacetic acid (GLDA) or polyaspartates. The carboxylates may be present as mixtures or formulated with other biodegradable chelants such as iminosuccinates and phosphonates.

Compounds (a) of specific interest according to the instant invention include gluconate salts as obtained by the reaction of glucono deltalactone with an alkanolamine (e.g. diethanolamine).

Gluconate salt of diethanolamine, sodium glucoheptonate and sodium polyaspartate are i.a. compounds (a) of interest.

Without being linked by a specific theory, it seems that the compound (a) of the invention, especially when it is a gluconate salt, forms a protective barrier by depositing as a thin layer on the surface of the metal substrate to be protected, with a deposition mechanism influenced by the concentration of the polyhydroxy acid salt, electrolyte concentration (ionic strength) and the brine chemistry (presence of hard water cations). At a fixed concentration of the gluconate, the corrosion inhibition performance was observed by the inventors to improve as the electrolyte concentration increased.

Furthermore, the corrosion inhibition properties seems to be better when the composition comprises or is used with calcium cations. For example, the inventors observed that corrosion inhibition properties of the gluconate are enhanced in CaCl2 brines compared to NaCl brines. The reason for the enhanced corrosion inhibition is likely to be the result of the deposition of a film of calcium gluconate on the surface of the metal substrate.

Whatever their exact composition, compound (a) is preferably present in the composition of the invention at a content of about 0.1 to 50% by weight, typically between 1 to 40%, for example between 10 and 30%, based on the total weight of the composition.

### The Compound (b)

Whatever their exact composition, compound (b) is preferably present in the composition of the invention at a content of about 0.1 to 50% by weight, typically between 1 to 40%, for example between 10 and 30%, based on the total weight of the composition based on the total weight of the composition.

Besides, the mass ratio (a)/(b) of the polyhydroxyl compound (a) to the cationic compound (b) is typically from 90/10 to 10/90, preferably from 75/25 to 25/75.

### Possible Additives

In addition to compounds (c) (antioxidant), typically present at a content of at most 5% by weight based on the total weight of the composition, and (d) (buffer) described herein above, a composition according to the instant invention may further comprise additional additives, depending on the specific application where it has to be used.

According to a possible embodiment, a composition according to the invention may independently contain (or alternatively be free from) one or more of the following component:
sulphur compounds synergists such as sodium thiosulfate: their presence is advantageous since it has now be found they tend to boost the performance of the corrosion inhibition (typically, when such a sulphur compound is used, its content is of 0.1-5% by weight, for example from 0.5 to 3%, based on the total weight of the composition).
passivating agents such as sodium molybdate and carboxylate-molybdate complexes (the presence of which is not necessary)
component inducing a foaming and or emulsioning effect: their presence is absolutely not required and they can be avoided in the scope of the invention, which is an advantage in comparison with the anticorrosion surfactant described in the prior art. However, according to a specific embodiment, if the foaming or emulsification is not an issue, the composition may contain foaming agents or emulsifiers. For example, it may contain surfactants, wetting agents, scale inhibitors and/or solvents (generally for a total of less than 50% by weight, based on the total weight of the composition).
winterizing agent, typically glycols and/or glycol ethers (typically at a content of 0.1-10% by weight based on the total weight of the composition, if any).

### Applications

The composition of the invention is suitable for use as a corrosion inhibitor in produced fluids or concentrated electrolyte systems, such as weighted oilfield brines for drilling applications, e.g. NaCl, KCl, CaCl2, ZnCl2, NaBr, KBr, Na Formate, K formate and Cs Formate, typically with an SG of 1.1-2.8.

The composition of the invention is compatible with both low and high TDS (total dissolved solids) brines, contrary to the film forming surfactant corrosion inhibitors described so far.

The composition of the invention may be used in topside oilfield applications as well as a corrosion inhibitor system in weighted or heavy brines for drilling, completion and workover operations. The biodegradable chelant/quat compositions can be used as an additive in corrosion inhibitor formulations, detergents, e.g. oil rig or bilge tank cleaners, and foamers for gas well deliquification or underbalanced drilling (foams) applications.

The composition of the invention may be used alone or as a secondary or tertiary component in a corrosion inhibitor or oilfield formulation. The use level of compounds (a) and (b) is typically 0.1-10.0% a.i., though more concentrated formulations, i.e. 50-80% a.i. may be used where space is a premium for the storage of chemicals, i.e. offshore facilities.

The composition of the invention may more generally be used as an additive in corrosion inhibitor formulations, detergents, e.g. oil rig or bilge tank cleaners, and foamers for gas well deliquification or underbalanced drilling (foams) applications.

The composition of the invention is especially relevant for general oilfield applications, in particular for the management of corrosion in oilfield production facilities, both topside and subsurface installations, e.g. refineries, transport infrastructure (pipelines, storage tanks), oil and gas wells. The composition of the invention may be used as a corrosion inhibitor for well casings and as an additive in drilling, hydraulic fracturing and well completion applications such as spacer fluids.

A typical composition according to the invention, suitable e.g. for high TDS brine may for example comprise the following ingredients:

| Component | % w/w |
|---|---|
| Compound (a), for example gluconate salt of diethanolamine, | 0.1-50.0 |
| sodium glucoheptonate or sodium polyaspartate | |
| Compound (b), e.g. choline chloride | 0.1-50.0 |
| Winterising agents, e.g. glycols and glycol ethers | 0.1-10.0 |
| Wettin or dispersing agents, e.g. surfactants | 0.1-5.0 |
| Sulfur synergist, e.g. sodium thiosulfate or preferable | 0.1-5.0 |
| compound (c) | |
| Scale Inhibitors, e.g. halite, phosphonates etc. | 0.1-5.0 |
| Scavengers, e.g. oxygen, hydrogen sulfide | 0.1-5.0 |
| Water | Balance |

A typical composition according to the invention, suitable e.g. for low TDS brine or freshwater applications may contain surfactants for detergency, dispersants or use as film forming corrosion inhibitors, and for example be as follows:

| Component | % w/w |
|---|---|
| Surfactant corrosion inhibitor, e.g. C8-18 alkyl | 0.1-50.0 |
| amidoamine, C8-C18 alkyl diamine, C8-18 alkyl | |
| trimethyl ammonium or dialkyl dimethylammonium halide, | |
| C8-18 ester quats, C18-18 amidopropyl betaine, C8-C18 | |
| alkyl ampho(di)acetate or C8-18 alkyl | |
| amphodipropionate, C8-18 alkyl iminodipropionate, | |
| C8-18 alkyl or alkyl ethoxy phosphate ester, C8-18 alkyl | |
| ether carboxylate, C8-18 alkylor dialkyl sulfosuccinate | |
| and C8-18 alkyl ethoxy sulfosuccinate, C8-18 acyl | |
| sarcosinate, C8-18 acyl glutamate, C8-18 acyl | |
| glycinate, C8-18 acyl taurate, C8-18 alkyl | |
| polyglucoside, C8-18 alcohol alkoxylates (EO or EO/PO) | |
| Compound (a), e.g. gluconate salt of diethanolamine, | 0.1-10.0 |
| sodium glucoheptonate or sodium polyaspartate | |
| Compound (b) e.g. choline chloride | 0.1-10.0 |
| Winterising agents, e.g. glycols and glycol ethers | 0.1-10.0 |
| Wetting or dispersing agents, e.g. surfactants | 0.1-50.0 |
| Sulfur synergist, e.g. sodium thiosulfate or preferably | 0.1-5.0 |
| compound (c) | |
| Scale Inhibitors, e.g. halite, phosphonates etc. | 0.1-5.0 |
| Water | Balance |

The composition of the invention have been developed for oilfield applications, but may be used in any field where a corrosion inhibition is sought.

For example, the composition of the invention may be used for limiting/avoiding corrosion in agrochemical applications, for example for protecting metallic surfaces from fertilizer formulations that can be highly corrosive. The use of choline chloride as compound (b) is of specific interest in this scope, since this compound acts as a bio-activator.

The following examples illustrate the invention.

### EXAMPLES

The performance of compositions according to the invention were assessed using ASTM methodologies, i.e. ASTM G170-06 (2012) for the assessment of corrosion inhibitors for oilfield and refinery applications. The corrosion rates were determined for a range of different metals by immersing test coupons in the aqueous electrolyte solutions. The compounds (a) and (b) were added to the solutions and the weight loss was determined over a period of seven days at 50° C. or 80° C. respectively. The active concentration of the corrosion inhibitors was fixed.

An illustration of the synergistic behaviour of the compounds present in the compositions of the invention is given for the gluconate diethanolamine salt (GDES) as compound (a) and choline chloride as compound (b) at 80° C. using N80 steel (well casing) coupons immersed in the aqueous brine solutions for seven days. The solutions were stored at atmospheric pressure for the period of the test.

The total active inhibitor concentration was 4.0%.

The gluconate diethanolamine salt (50% aqueous solution) was benchmarked against choline chloride and didecyl dimethyl ammonium chloride (FENTACARE D1021-80) respectively (see table) in the NaCl and CaCl2 brines.

The corrosion rate (mils/year) was calculated from the weight loss measurements.

The surfactant, FENTACARE D1021-80 is not soluble in the brine and formed an insoluble organic layer on the surface of the brine.

The corrosion rate of the coupon immersed in the surfactant solution was found to be comparable to the blank (no corrosion inhibitor). The gluconate however was found to be an effective corrosion inhibitor and there was a further reduction in the corrosion rate when 50% of the gluconate was replaced by the surfactant.

Choline chloride is soluble in the high TDS brines and was observed to produce a similar response to the cationic surfactant in the immersion tests. Although choline chloride produces a slight reduction in the corrosion rate compared to the blank, replacing 50% of the choline chloride with the gluconate diethanolamine salt results in an effective corrosion inhibitor system. The corrosion rate is reduced by 50% compared to the gluconate in 20% w/w NaCl and CaCl2 respectively.

Immersion corrosion inhibition data for GDES/quat systems in high TDS brines at 80 oC with N80 steel (well casing) test coupons

| | Brine | | | | |
|---|---|---|---|---|---|
| | Concen- | | | | Corrosion |
| | tration | | Weight | Weight | Rate |
| Brine | (%) | Component | Loss (mg) | Loss (%) | (mils/year) |
| NaCl | 20 | Blank | 11.4 | 0.039 | 1.015 |
| | | 4% a.i. | 3.4 | 0.012 | 0.303 |
| | | GDES | | | |
| | | 4% a.i. 50/50 | 2.3 | 0.008 | 0.205 |
| | | GDES & | | | |
| | | Choline | | | |
| | | Chloride | | | |
| | | 4% a.i. | 7.9 | 0.027 | 0.703 |
| | | Choline | | | |
| | | Chloride | | | |
| | | Blank | 16.2 | 0.056 | 1.438 |
| | | 4% a.i. | 4.1 | 0.014 | 0.364 |
| | | GDES | | | |
| | | 4% a.i. 50/50 | 3.4 | 0.012 | 0.302 |
| | | GDES & | | | |
| | | FENTACARE | | | |
| | | D1021-80 | | | |
| | | 4% a.i. | 12.3 | 0.043 | 1.092 |
| | | FENTACARE | | | |
| | | D1021-80 | | | |
| CaCl2 | 20 | Blank | 10.4 | 0.036 | 0.926 |
| | | 4% a.i. | 2.9 | 0.010 | 0.258 |
| | | GDES | | | |
| | | 4% a.i. 50/50 | 1.8 | 0.006 | 0.16 |
| | | GDES & | | | |
| | | Choline | | | |
| | | Chloride | | | |
| | | 4% a.i. | 9.8 | 0.034 | 0.872 |
| | | Choline | | | |
| | | Chloride | | | |
| | | Blank | 10.5 | 0.036 | 0.932 |
| | | 4% a.i. | 1.5 | 0.005 | 0.133 |
| | | GDES | | | |
| | | 4% a.i. 50/50 | 1.0 | 0.003 | 0.089 |
| | | GDES & | | | |
| | | FENTACARE | | | |
| | | D1021-80 | | | |
| | | 4% a.i. | 19.3 | 0.066 | 1.713 |
| | | FENTACARE | | | |
| | | D1021-80 | | | |

The effect of the combination of the gluconate and chloline chloride is even enhanced when combined with an antioxidant, such as erythorbic acid or neutralized salts of erythorbic acid, in aerated systems compared to the gluconate with or without the antioxidant.

The advantage of using an antioxidant instead of traditional oxygen scavengers such as bisulfites is that it does not form an oxidised residue that precipitates from the brine. Bisulfites form sulfates that are liable to precipitate from the brine and may cause additional corrosion problems.

RCE measurements with an oxygen saturated brine (1000 rpm, 30% CaCl2 at 50° C.) clearly demonstrated the individual components of the formulation (gluconate, chloline chloride and erythorbic acid (potassium salt) do not exhibit any appreciable improvement, with the exception of choline chloride, in the protection against corrosion. The oxygen levels were monitored and a summary of the results are given in the following table.

C1018 corrosion rates obtained with the ingredients

| | | | | | | Temperature | | | |
|---|---|---|---|---|---|---|---|---|---|
| | pH | | Oxygen (mg/l) | | | (° C.) | | Average corrosion rate | |
| Formulation | Start | End | Start | End | Difference | Start | End | (mils/yr) | Efficiency after 15 hours |
| Blank | 5.63 | 5.48 | 5.23 | 5.2 | 0.03 | 21 | 41 | 37.69 | / |
| 10000 ppm GDES, | 6.53 | 7.85 | 5.35 | 2.1 | 3.25 | 21.1 | 44.5 | 65.17 | 0 (−93.3)** |
| 1000 rpm | | | | | | | | | |
| 10000 ppm | 5.65 | 5.59 | 5.14 | 2.25 | 2.89 | 21 | 43.2 | 26.8 | 50.62 |
| Choline Chloride, | | | | | | | | | |
| 1000 rpm | | | | | | | | | |
| 5000 ppm | 6.34 | 3.38 | 2.71 | 1.22 | 1.49 | 39 | 43 | 35.21 | 0 (−1.45)** |
| Isoascorbic acid*, | | | | | | | | | |
| 1000 rpm | | | | | | | | | |

Note:
A 10% aqueous solution of the antioxidant* was neutralised with KOH (pH 5-6) and used for the tests.
Negative inhibitor efficiencies indicate corrosion.
Similar results were observed for the mixtures of the ingredients without the antioxidant.

C1018 corrosion rates obtained with choline chloride and Gluconate
Diethanolamine (GDES)

| | | | | | | Temperature | | | |
|---|---|---|---|---|---|---|---|---|---|
| | pH | | Oxygen (mg/l) | | | (° C.) | | Average corrosion rate | |
| Formulation | Start | End | Start | End | Difference | Start | End | (mils/yr) | Efficiency after 15 hours |
| Blank | 5.63 | 5.48 | 5.23 | 5.2 | 0.03 | 21 | 41 | 37.69 | / |
| 10000 ppm GDES, | 6.53 | 7.85 | 5.35 | 2.1 | 3.25 | 21.1 | 44.5 | 65.17 | 0 (−93.3) |
| 1000 rpm | | | | | | | | | |
| 10000 ppm 50/50 | 5.66 | 8.42 | 4.07 | 2.3 | 1.77 | 21.3 | 43 | 68.55 | 0 (−90.86) |
| GDES/Choline | | | | | | | | | |
| Chloride, | | | | | | | | | |
| 1000 rpm | | | | | | | | | |
| 10000 ppm | 5.11 | 1.68 | 5.49 | 3.33 | 2.16 | 20 | 40 | 149.25 | 0 (−434.6) |
| Choline Chloride + | | | | | | | | | |
| 5000 ppm | | | | | | | | | |
| Isoascorbic acid, | | | | | | | | | |
| 1000 rpm | | | | | | | | | |

When the antioxidant is added to the formulation (2:1 inhibitor/antioxidant ratio), there was a significant improvement in the overall corrosion inhibitor efficiency. An additional synergy of mixing the ingredients is that the oxygen content of the brine was reduced to <0.1 mg/l, thus mitigating the effects of corrosion due to the presence of oxygen.

C1018 corrosion rates obtained for the corrosion inhibitor formulations with the
antioxidant*

| | | | | | | Temperature | | | |
|---|---|---|---|---|---|---|---|---|---|
| | pH | | Oxygen (mg/l) | | | (° C.) | | Average corrosion rate | |
| Formulation | Start | End | Start | End | Difference | Start | End | (mils/yr) | Efficiency after 15 hours |
| Blank | 5.63 | 5.48 | 5.23 | 5.2 | 0.03 | 21 | 41 | 37.69 | / |
| 10000 ppm | 4.6 | 6.4 | 4.36 | 0.08 | 4.28 | 20 | 45 | 10.05 | 89.3 |
| GDES + | | | | | | | | | |
| 5000 ppm | | | | | | | | | |
| Isoascorbic | | | | | | | | | |
| acid*, 1000 rpm | | | | | | | | | |
| 10000 ppm | 5.96 | 7.25 | 3.29 | 0.05 | 3.24 | 23.5 | 41 | 7.22 | 95.53 |
| 50/50 | | | | | | | | | |
| GDES/Choline | | | | | | | | | |
| Chloride + | | | | | | | | | |
| 5000 ppm | | | | | | | | | |
| Isoascorbic | | | | | | | | | |
| acid*, 1000 rpm | | | | | | | | | |

Note:
A 10% aqueous solution of the antioxidant* was neutralised with KOH (pH 5-6) and used for the tests.

It is clearly seen the combination of the gluconate with choline chloride has superior inhibition performance compared to the gluconate with the antioxidant.

1. A corrosion inhibitor composition comprising:
(a) at least one biodegradable polyhydroxyacid and/or polyhydroxylated derivative thereof; and
(b) a biodegradable cationic compound having a molecular weight of less than 500 Da.

2. The composition of claim 1, wherein the biodegradable polyhydroxyacid and/or polyhydroxylated derivative thereof (a) is selected from the group consisting of:
biodegradable polyhydroxy acids;
metal salts of such biodegradable polyhydroxy acids;
alkanolamine salts of such biodegradable polyhydroxy acids;
polyhydroxy amides obtainable by reaction of alkanolamines with such biodegradable polyhydroxy acids; and
mixtures thereof.

3. The composition of claim 2, wherein the biodegradable polyhydroxyacid and/or polyhydroxylated derivative thereof (a) is gluconic acid.

4. The composition of claim 1, wherein the biodegradable cationic compound (b) is:
a choline salt (choline being trimethyl (2-hydroxyethyl) ammonium hydroxide);
a (C₁-C₃ alkyl)trimethylammonium or di(C₁-C₃ alkyl) dimethylammonium salt;
a dihydroxy tri(C₁-C₃ alkyl) ammonium halide or dihydroxy tri(C1-C3 hydroxyalkyl) ammonium halide;
a cationic compound as obtained by the hydrolysis of chlorohydroxalkyl tri(C₁-C₃ alkyl or hydroxalkyl) ammonium salts; or
a mixture of two or more of said salts.

5. The composition of claim 4, wherein the biodegradable cationic compound (b) is a choline salt.

6. The composition of claim 1, further comprising:
(c) an antioxidant.

7. The composition of claim 1, further comprising:
(d) a pH buffer.

8. The composition of claim 1, comprising (a) gluconic acid; (b) a choline salt; and (c) an antioxidant.

9. A corrosion inhibitor composition comprising:
at least one biodegradable polyhydroxyacid and/or polyhydroxylated derivative thereof;
an antioxidant; and
a buffer.

10. A method for providing an anticorrosion effect on a metallic surface comprising using the corrosion inhibitor according to claim 1.

11. The method of claim 10 for providing an anticorrosion effect on a metallic surface, wherein the metallic surface is in contact with an oxygenated oilfield fluid.

12. The corrosion inhibitor composition according to claim 1, wherein the at least one biodegradable polyhydroxyacid and/or polyhydroxylated derivative thereof is a polyhydroxyacid that is all or part in the form a polyhydroxylated salt and/or a polyhydroxyamide.

13. The corrosion inhibitor composition according to claim 1, wherein the biodegradable cationic compound has a molecular weight of between 50 and 400 Da.

14. The composition of claim 2, wherein the biodegradable polyhydroxy acid is gluconic acid, tartaric acid, polyaspartic acid and/or glutamic acid.

15. The composition of claim 3, wherein the gluconic acid is all or part in the form of a salt or an amide.

16. The composition of claim 4, wherein the biodegradable cationic compound (b) is choline chloride having a molecular weight of about 140 Da, that is well biodegradable.

17. The composition of claim 7, wherein the pH buffer contains CaO.

18. The composition of claim 8, wherein gluconic acid is all or part in the form of gluconate salts.

19. The composition of claim 8, wherein the antioxidant is isoascorbic acid and/or a salt thereof.

20. The method of claim 11, wherein the oxygenated oilfield fluid is a high TDS brine.
